(19) United States
(12) Patent Application Publication
(10) Pub. No.: US 2010/0021220 A1
(43) Pub. Date: Jan. 28, 2010

(54) APPARATUS AND METHOD OF REDUCING WARPAGE OF SHEET PRINT MEDIA IN A STACKER

(75) Inventors: Chris Watts, Hertfordshire (GB); Lee Monahan, Hertfordshire (GB)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/180,669

(22) Filed: Jul. 28, 2008

(51) Int. Cl. G03G 15/00

(52) U.S. Cl. 399/405

(57) ABSTRACT

A low voltage flexible heater for installation in the base of a printer cabinet and operating on 28 volts or less and providing continuous surface temperatures of 200° C. for convective drying of paper in the print sheet stacker. The pad may be formed of silicone rubber with adhesive backing for ease of installation.

### BACKGROUND

The present disclosure relates to photo printing or copying on sheet print media where the sheets are fed from a stack into a printer or photocopier for marking. In service, it has been found that during periods of operation of such devices in high humidity climatic conditions, the sheet print media and particularly sheet paper stock is subject to excessive curling which results in paper jams upon entering the feeder. In particular, in regions where the humidity is 80% or higher, paper curling occurs quite often and significantly reduces the productivity of the printing due to machine jamming from paper mis-feed.

Heretofore, attempts have been made to reduce the curling of the sheet paper stock in high moisture conditions by providing a heater under the stack of paper, drying the paper by natural convection to thereby reduce the curling and jamming. Such attempts involved installing line voltage ceramic block mounted heating elements in the machine compartments immediately beneath the sheet paper stack to provide heated air for drying the paper. These block heaters provided an electrical shock hazard by virtue of their line voltage connections and thus required costly shielding and safety devices to prevent user shock, shorting and over-heating. Furthermore, the installation of the block heaters and the wiring interconnections necessary to effect their operation has been found to be costly and time consuming where retrofitted to existing photocopiers. Thus, it has been desired to provide a less costly, efficient and electrically safer way of drying the sheet paper stack in a printer/photocopier and which is simple and easy to install in the machine.

The present disclosure describes a low-voltage flexible pad-like heater or heating pad which may be disposed in the bottom of the cabinet for a sheet paper stacker/feeder for convective drying of the sheet stock in the stack and which is simple and easy to install. The heating pad disclosed herein is of the type employing a resistance wire heating element embedded in silicon rubber which has resistance to elevated temperatures and provides excellent electrical insulating properties. The air surface heating pad of the present disclosure operates at a maximum continuous heating temperature of 200° C. and can withstand over temperature excursions as high as 230° C. The pad is thin and lightweight with a low thermal mass thus providing rapid heat-up and relatively quick response to temperature controlling. The pad may be molded to the configuration of the bottom of the cabinet to provide simple installation yet optimize the amount of heating element present for the cabinet configuration. The heating pad may be manufactured with a self-adhesive backing to allow for ease of installation in the cabinet of the stacker/feeder.

### BRIEF DESCRIPTION OF THE DRAWINGS

FIG. 1 is a side elevation view of a typical photocopier/printer with a sheet media stacker/feeder attached;

FIG. 2 is a perspective view of the bottom of the cabinet for the stacker/feeder of FIG. 1 with the heating pad installed; and,

FIG. 3 is a pictorial view of the heating pad of the present disclosure.

### DETAILED DESCRIPTION

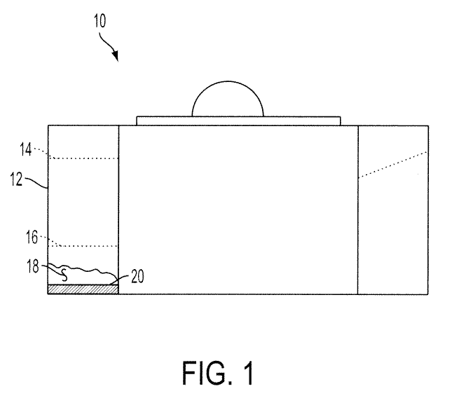

Referring to FIG. 1, a photocopier/printer indicated generally at 10 includes a stagger/feeder 12 having a tray stacked with sheet paper stock indicated at 14 in dashed outline. The paper stacker 14 has a compartment provided below the movable lower tray indicated at 16 in dashed outline with the compartment denoted by reference numeral 18. The compartment 18 is formed above the bottom pan 20 of the cabinet or the feeder/stacker 12.

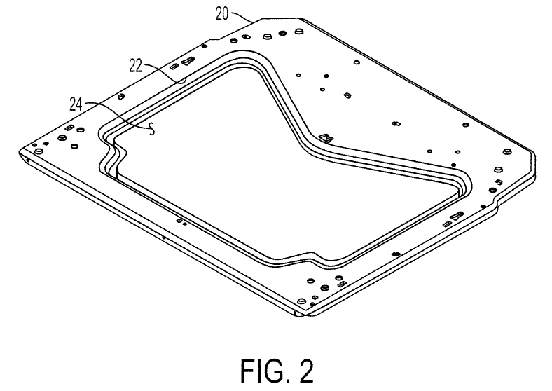

Referring to FIG. 2, the bottom 20 of the cabinet for the stacker/feeder 12 is shown as having an indent or recessed portion denoted by the outline 22; and, the flexible feeder pad 24 of the present disclosure is disposed in the recessed area 22 of the cabinet bottom 20.

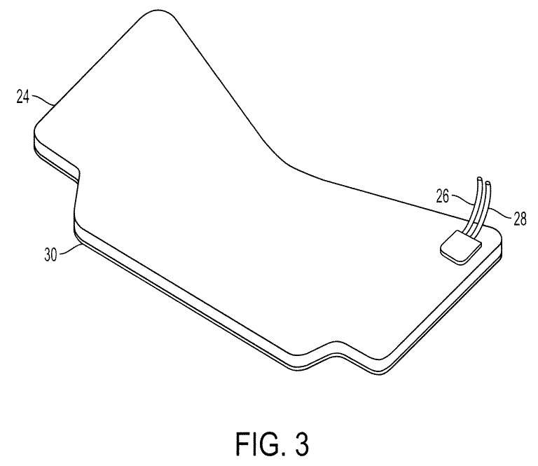

Referring to FIG. 3, the heater pad 24 is shown with its periphery cut or molded to a configuration so as to fit within the shape of the recess 22. The heater pad 24 has electrical leads 26, 28 attached thereto and extending from the upper surface thereof for connection to the source of electrical energization. In the present practice, the heater pad 24 is flexible and formed of suitable high temperature material, as for example silicone elastomer with resistance wire heating elements molded there within and connected to the leads 26, 28. The heating pad 24 is intended for operation on a 24 volt power supply and operates at a maximum continuous temperature of 200° C. with excursions up to 230° C. tolerated for short periods of time. The undersurface of the pad 24 may be coated with a suitable acrylic self adhesive backing 30 to allow for ease of installation in the cabinet and for permanent retention therein. Alternatively, eyelets, straps, hooks, or loop engaging fabric may be employed for retaining the heater in position. The heater pad 24 described herein provides sufficient heating of the air beneath the paper stack 16 to provide the requisite drying of the paper in high moisture climatic conditions and particularly where 80%. In the present practice it has been satisfactory to utilize a heater pad manufactured by Holroyd Components Ltd, Shire Hill Industrial Estate, Saffron Walden, Essex, England. However, other suitable heating pads capable of operating on 24 volts power supply may be employed provided that the material surrounding the heating elements is flexible and capable of withstanding similar operating temperatures.

The flexible heater pad of the present disclosure is thus readily installable in the base of a sheet stacker/feeder by virtue of the adhesive backing and provides protection from electrical shock by operating only on low voltage power supply. The sheet paper in the stacker/feeder may thus be maintained in a desired state of dryness by natural convection of the air rising from the heater pad.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of reducing warpage/curling of sheet print media in a stacker/feeder comprising:
(a) disposing a stack of sheet print media in a feeder receptacle;
(b) providing a flexible electric heating pad capable of operating on a power source of not more than about 28 volts;
(c) attaching the pad to the support structure of the receptacle; and,
(d) energizing the heater pad and heating the sheet print media.

2. The method defined in claim 1, wherein the step of providing a heater pad includes providing a heater pad with a maximum power consumption of about 40 watts.

3. The method defined in claim 1, wherein the step of heating includes heating the print sheet media in the range of about 30-50° C.

4. The method defined in claim 1, wherein the step of attaching includes adhesively bonding the heater pad to the support structure.

5. The method defined in claim 1, wherein the step of providing includes providing a heater pad capable of operating on a 24 volt power source.

6. The method defined in claim 5, wherein the step of providing includes providing a heater operating on a current of about 1.7 amperes.

7. A sheet print media stacker/feeder for a print engine comprising:
(a) a receptacle/tray for receiving a stack of print sheet media;
(b) support structure at least partially enclosing the receptacle/tray; and,
(c) a flexible electric heating pad attached to the support wherein the heating pad is intended for operation from a power source of not more than about 28 volts.

8. The stacker/feeder defined in claim 7, wherein the heating pad is adhesively attached to the support structure.

9. The stacker/tray defined in claim 7, wherein the heating pad has a maximum power consumption of about 40 watts.

10. The stacker/tray defined in claim 7, wherein the heating pad when energized operates in the range of about 30-50° C.

11. The stacker/feeder defined in claim 7, wherein the heating pad operates on a current of about 1.7 amperes.

12. The stacker/feeder defined in claim 7, wherein the heating pad is intended for operation on a 24 volt source of power.
